(19) United States
(12) Patent Application Publication
(10) Pub. No.: US 2006/0173699 A1
(43) Pub. Date: Aug. 3, 2006

(54) Virtual technology transfer network

(76) Inventor: Tanaga Anne Boozer, Tallahassee, FL (US)

Correspondence Address: FLORIDA A&M UNIVERSITY, 2077 E. PAUL DIRAC DRIVE, TALLAHASSEE, FL, 32310, US

(21) Appl. No.: 11/049,265

(22) Filed: Feb. 2, 2005

(51) Int. Cl. G06Q 99/00

(52) U.S. Cl. 705/1

(57) ABSTRACT

A Virtual technology transfer Office and method for a) accessing a secure on-line system for entering, retrieving, displaying, editing, storing and printing technology transfer and intellectual property information; b) utilizing voice commands or manually entered numeric, alpha or alphanumeric characters to navigate through the an on-line electronic interactive environment. c) Performing instantaneous on-line searching, ranking and scoring of invention disclosure based on relevant prior art; d) working on the internet or on-line meeting place alone or with others. e) Drafting or revising documents alone or in tandem in a virtual meeting place; f) Sending and receiving electronic notifications; g) Sending and receiving messages; h) Creating, reviewing, revising, attaching and printing documents; i) Searching Patent & Literature Bases instantaneously or immediately; j) creating and sending electronic bids to contract attorneys; compiling, ranking and selecting attorneys for the work; k) accepting and responding to electronic bids from contract attorneys; l) accepting and responding to invoices from contract attorneys; m) generating technology transfer and intellectual property documents n) filing of patent and trademark applications electronically; o) and submitting federal patent reports electronically.

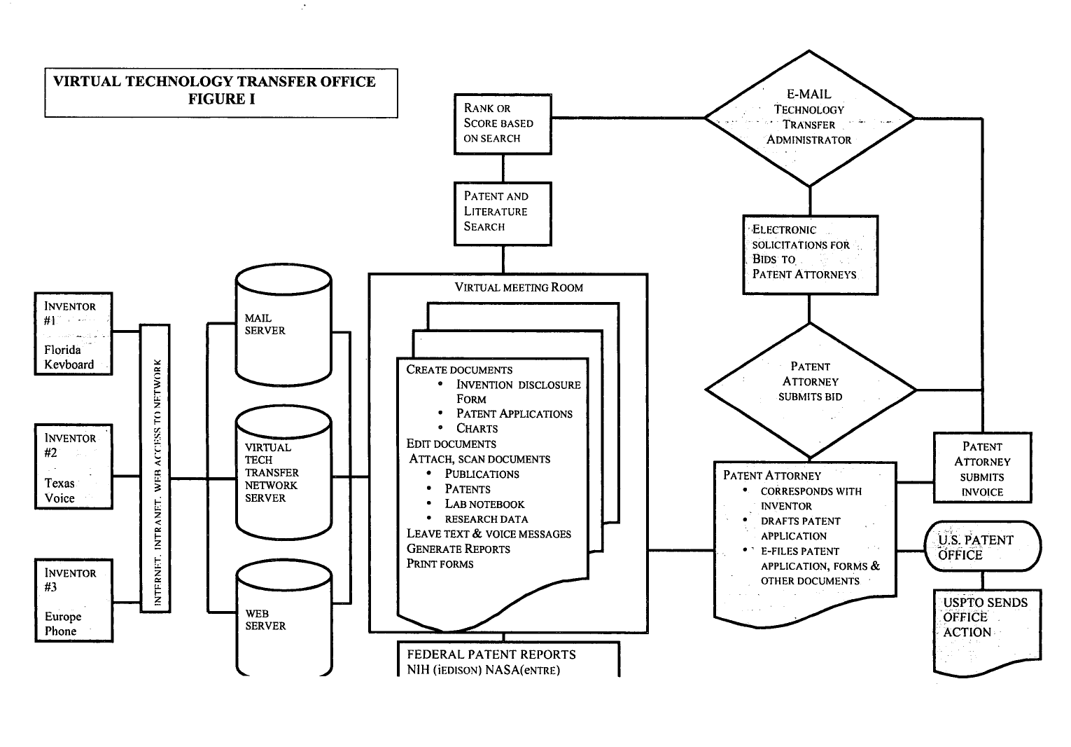

### BACKGROUND

Each year administrators at universities, hospitals, non-profits, research laboratories and managers at federal laboratories across this country are faced with tough budgetary decisions. One of the toughest decisions for managers and university administrators to make is the amount of money that will be allotted for intellectual property related expenses. Without sufficient funding these offices are faced with an insurmountable task. It is very difficult to create an infrastructure that fosters and stimulates innovation and creativity among university faculty without adding additional costs to the institution or organization. It is well known and accepted among university researchers that investing in intellectual property is one way to generate funds to fill the University's coffers. The virtual office is designed to improve the efficiency of existing university technology transfer offices and to reduce the costs associated with managing the office.

Generally, legal matters are handled in the Office of General Counsel, but at Universities with technology transfer offices, contracted law firms will manage the University's intellectual property legal matters. Some universities choose to use the same firm to protect all of their intellectual property while others choose to use many different firms or patent attorneys. However, it does not matter if one law firm is employed or several, an agreement between the University and the firm must be drafted and executed. The process of selecting and employing Intellectual Property (IP) attorneys can be a major time commitment. During the drafting process, invariably, there will be several revisions of the Contract for Private Attorney Services. The amount of processing time lost while drafting such agreements and waiting on specific approvals can be and is often enormous. The system solves this problem by employing attorneys that have been pre-selected as preferred providers of intellectual property services. Participating firms, attorneys and agents will be required to subscribe to the service by signing an agreement to perform services at a predetermined rate for the universities. Generally, the subscription will be for patent and licensing related activities, but can include other services as well. Therefore, once an invention has been disclosed, the process is not delayed because of the University's or organization's internal legal review and approval process.

The university technology transfer office is tasked with converting university intellectual property into usable products, services or systems. The process for making this happen is very time consuming and is replete with many, many meticulous procedures. In order to fully appreciate the innovative features of this system, a basic understanding of the existing technology transfer process is essential. In a nutshell, once researchers believe they have embarked upon something that is inventive and worthy of some form of legal protection, they will contact the Director of the Technology Transfer Office and complete an Invention Disclosure Form (IDF). Most IDFs contain some or all of the following information: Title of the Invention, Name of each inventor, home address, city, state, zip code, work telephone number, home telephone number, email address, University or Company, University Department, Dean of the College, abstract Brief Description of the Invention, Date of the Invention, Date the invention was reduced to practice, purpose of the invention, date of public disclosure, relevant patents, relevant literature, list of relevant patent numbers, list of relevant publications, source of funding, contract or grant number, contact person at funding agency, name of potential licensee, signature of each inventor, date and signature of Dean or Chairperson.

Once the IDF is completed, the Director will review and discuss the invention with the inventor in order to grasp the basic concepts of the invention. After this initial conversation, the Director sends a copy of the disclosure to an outside search firm that will perform a patent and literature search of the invention. The results of the search are returned to the Director of the Technology Transfer Office and the inventor. Based on the search results, the Intellectual Property Review Committee or Technology Transfer Director will determine if the invention should be patented. If patent protection is appropriate, a patent attorney will be selected to draft and file the patent application on behalf of the University inventor. The patent attorney will draft the patent application with the assistance of the inventor. This process is very lengthy and generally takes several months before a patent application can be filed.

The technology transfer process is as complex as a 1000 piece jigsaw puzzle. The ability to effectively manage each function is inextricably linked to the success of the technology transfer office. There are several different pieces to the university technology transfer puzzle and each piece of the puzzle must be managed effectively. The managerial responsibilities include managing the office staff, the intellectual property portfolio, inventors, law firms, licensees, licensors, licensing revenue, royalty payments, etc. Until now, there has never been a program designed specifically to create a virtual technology transfer office. The system and method of this invention were created so that many of the tasks that were performed manually by technology transfer staff; inventors, administrators, patent attorneys and government agencies could be done electronically in a virtual environment. This is particularly important because the electronic environment significantly reduces the costs and increases the efficiency of the technology transfer office. Thus, it is an affordable alternative for technology transfer offices that are constantly fighting for financial resources to support their offices.

The motivation for developing the system was to enable universities and other organizations that wanted or needed to have access to technology transfer services, but had budgetary challenges that either prohibited participation in this commercial enterprise or while the system reduces the costs associated with having an on-campus or on-site technology transfer office, it does not eliminate all of the expenses associated with procuring legal protection of intellectual property. At most majority institutions, even those with mature technology transfer offices, the amount of time and financial resources spent throughout the entire process from invention disclosure to commercialization can be enormous. While the technology transfer process is very complex and time consuming, an electronic system optimizes the functionality of the office by eliminating both the obvious and unobvious inefficiencies of the technology transfer labyrinth. It is foreseeable that the system could be used by to electronically draft provisional, non-provisional and PCT patent applications. The applications can be drafted based on prompts by the VTTO administrator to the users regarding the invention.

“Virtual” is a term used to describe the overall environment that will be used to manage the system. “Virtual” and “online” as used in this invention means utilizing an integrated system of computers, servers, Internet access, Intranet access and various web and electronic resources to facilitate technology transfer related activities and events. Now that businesses are fully engaged in e-commerce and processing multiple online transactions in a secure environment, the virtual network is a viable option for managing technology transfer activities, forms and events. “Technology Transfer” is a broad category and generally includes all aspects of protecting and commercializing the intellectual assets of universities, governments and industries. Intellectual assets generally include patents, trademarks, copyrights, trade secrets, know-how and electronic course materials, etc.

### SUMMARY OF THE INVENTION

The invention describes a Virtual Technology Transfer Office that is a both a network and a method for managing and coordinating the functions of the traditional Technology Transfer Office. The method involves at least one of the following steps: a) accessing a secure on-line secure system for entering, retrieving, displaying, editing, storing and printing technology transfer and intellectual property information; b) utilizing voice commands or manually entered numeric, alpha or alphanumeric characters to navigate through an on-line electronic interactive environment. c) performing instantaneous on-line searching, ranking and scoring of invention disclosure based on relevant prior art; d) working on the internet or on-line meeting place alone or with others. e) drafting or revising documents alone or in tandem in a virtual meeting place; f) sending and receiving electronic notifications; g) sending and receiving messages; h) creating, reviewing, revising, attaching and printing documents; i) searching patent & literature searches instantaneously or immediately; j) creating and sending electronic bids to contract attorneys; compiling, ranking and selecting attorneys for the work; k) accepting and responding to electronic bids from contract attorneys; l) accepting and responding to invoices from contract attorneys; m) generating technology transfer and intellectual property documents, n) filing of patent and trademark applications electronically and; o) submitting federal patent reports electronically.

Users can enter data into the system using any of the following devices, the use of internet resources, computers, computer networks, Personal Data Assistants (PDA's), handheld devices, cell phones and appropriate computer software programs for each function stated in the above claim.

The method is an innovative and holistic approach to technology transfer. The method creates a process that permits universities to electronically manage most, if not all, of the technology transfer activities, people, events, correspondences, documents and budgets. “Thomas,” the virtual technology transfer administrator administers the system. “Thomas” interacts with users by voice or text. Thomas provides the user with a “real life” technology transfer experience. If, however, users prefer Text, Thomas also communicates using computer generated prompts, queries and messages. This mode allows the user to manually enter responses into the technology transfer system.

The method eliminates several possible inefficient processes that exist in the traditional technology transfer office. One such process is the way invention disclosure materials are processed, (i.e. the amount of time it takes and the costs required for sending disclosure materials to the attorney). The primary delay observed here is due to mail. Once an attorney has been selected to perform work for an office, the technology transfer staff must send all relevant materials and documents to the attorneys by U.S. Mail, FAX or by email. However, in the virtual environment, all disclosure materials are either scanned into the virtual office or created in the virtual office. Thus, once the attorney has been selected, immediate access is granted to the disclosure materials that are already conveniently located in the virtual office.

A second possible inefficient process is the patent drafting process. This delay is usually associated with the scheduling conflicts that exist among the parties. In order to draft the patent application, the attorney must maintain constant contact with inventor. The problem is exacerbated when there are multiple inventors for the same invention. However, by selecting a lead inventor this problem is negated considerably. The lead inventor is the only inventor the attorney contacts while drafting and prosecuting a patent application unless there is a need to do otherwise. This designation is primarily for the convenience of the attorney, but does not eliminate the need for the co-inventors to work together to assist the attorney with drafting the patent application. No matter which inventor assumes the role as lead inventor, each named inventor is held accountable for the accuracy and validity of the entire document. Generally, the lead inventor reviews the draft application, and then circulates a single copy of the draft to each co-inventor for editing. The problem here is the amount of time it takes each inventor to review and edit the draft before passing it on to the other co-inventors and then finally getting the draft back to the attorney. Working from a single copy of the patent application creates a plethora of problems for users. The greatest challenge is to keep the “marked up” copy circulating. The virtual system flows effortlessly without delay because the inventors have access to the draft document at all times. Except when the attorney or another inventor is reviewing the application. By now, the possible inefficiencies that could exist in the traditional technology transfer office should be blatantly obvious. The virtual system works well because the process remains dynamic even when individuals cannot meet at the same time or in the same place.

Not only does an electronic system eradicate inefficiencies, but it also provides a means for obtaining information “on demand” without expending a significant amount of time or other resources. The VTTO assists users with obtaining immediate or instantaneous feedback regarding the novelty of an invention. The virtual system provides users with feedback by searching available on-line resources for existing literature and patent information. When performing a patent search, one of the primary tools used for the searching will be the USPTO'S Manual of Classification and Index and existing patent and literature databases.

### DETAIL DESCRIPTION OF THE INVENTION

The Technology Transfer Network of Users. The Virtual Technology Transfer Network is an electronic system that links people, documents, courses, accounts and various resources in a virtual environment. It is important to recognize who the users are and how the users interact within the network. VTTO has at least four different types of users. The first user is the virtual technology transfer administrator or the system's manager. The second type of user is the attorney or law firm representative. The third type of user is the actual Participating Technology Transfer Office. The fourth user can be at least one of the following: University inventor, licensee, licensor, faculty member, student, university administrator, independent inventor, corporate employee, government employee. How each type of user interacts with the system is described below.

I. Technology Transfer Administrator (Virtual)

The Technology Transfer Administrator is responsible for a) managing a secure on-line internet accessible or web based database for each technology transfer office; b) maintaining at least two servers or one server capable of performing the functions of at least two servers; c) acquiring, updating and maintaining access to relevant literature and patent databases include any free U.S. or foreign patent and literature databases useful for prior art searching, d) assigning user identification and docket numbers to all users based on defined roles and privileges; e) granting access and managing access to certain menus and screen selections based on the users role; f) sending and receiving electronic notifications from various users particularly from inventors, faculty, students and attorneys, g) sending and receiving electronic bidding information to contract attorneys; h) maintaining and updating subscription information for all contract attorneys (each attorney is responsible for conducting a conflict of interest check prior to accepting work. Ideally, the conflict check should be done prior to submitting the bid); i) sending and receiving electronic contracts and invoices; j) authorizing payment to attorneys for services rendered; k) managing patent prosecution for all pending patents; l) sending and receiving all U.S. Patent Office correspondence; m) scanning all U.S. Patent Office correspondence into the electronic technology transfer file; n) ensuring that all contract attorneys comply with the Virtual Technology Transfer Policies; o) selecting only attorneys or firms that agree to file patent applications electronically; p) applying for and keeping on file all accounts, numbers and codes required to communicate with the Patent Office electronically; q) receiving and entering relevant information for participating Technology Transfer Office such as: policies, forms, documents, identification numbers, access codes and passwords into the database; r) maintaining secure system

II. Participating Attorneys

The system permits attorneys to: a) subscribe to the Virtual Technology Transfer Network b) select the level of service and to c) submit requests for service to the VTTO. For example, some attorneys may want to receive notification for only projects involving chemical or pharmaceutical inventions or some attorneys may want to select the universities that the attorneys will pay a subscription fee to participate in the network.

Different levels of service are available to the law firms and attorney. The Premium Service Plan entitles attorneys to receive Requests for all available work. Custom Service Plan allows attorneys to bid on selected work and for pre-selected clients. Access to the VTTO files are based on the subscription plan that is purchased. Work is awarded to attorneys based on several criteria not only the amount of the bid. Ideally, there will be a maximum fee that can be charged for participating in the system. The service should be affordable for the participating universities. The criteria includes: experience of the firm and/or attorney, the subject matter of the invention, the availability of the attorney/firm, the filing needs of the client, the price of the bid, the reputation of the firm/attorney with the VTTO, the electronic resources available to the firm/attorney, etc. The bids will be objectively evaluated by the electronic system and placed in rank order. However, the technology transfer administrator reviews the rankings before assigning the work to the attorney and then sends the selection notification.

III. Participating Technology Transfer Offices (University, Government, Hospitals, Industry)

Each participating technology transfer office operates under its own policies and procedures and utilizing its own forms and accounts. Universities will be expected to pay an annual fee for participation in the program. For the first year, the fee will be based on the anticipated number of invention disclosures and patent applications that will be filed for one year. The following year, the fee will be based on the previous year's activity. However, the system will automatically make an adjustment in the fee agreement when the following conditions are met: When the office has exceeded their projections by at least 25% and if the increase number of submissions and filings puts that office in a higher fee plan. If, however, there are changes to the existing Bayh-Dole legislation as suggested by the inventor, the cost of the service would be minimal. Ideally, university technology transfer offices electing to own federally sponsored inventions should demand that about 2%-5% of the grant to pay for the fees that are required for patent and commercialization. The inventor believes the requirements are illusory without the appropriate funding to support such activities. The VTTO stores and tracks all expenditures related to federally sponsored inventions disclosed using the system.

IV. Individual Users (Researchers, Inventors, Faculty, Students, etc.)

An individual interacting with the system can do so by voice activated commands or by manually entering the data into the computer. Once the user logs onto the system, “Thomas” the Technology Transfer Administrator begins to instruct the inventor on how to begin the invention disclosure process. At the beginning of every session, “Thomas” asks who will be attending the session. This is an important question because this activates the “simultaneous” editing function or permits the users to enter into a virtual meeting space for a meeting. If only one person is editing, other have controlled access to documents. All voice activated sessions are recorded for the convenience of individuals not attending the meeting. This feature is available only if the voice recognition feature is activated. “Thomas” will authenticate each inventor by asking the inventor to read a passage to ensure accuracy of the users responses.

Virtual Technology Transfer Office (VTTO)

The VTTO operates efficiently by collecting, storing and processing technology transfer and intellectual property data. It is a coordinated method involving some or all of the following step: a) accessing a network; b) assigning docket numbers; c) entering personal information of or concerning inventors the inventor's university, or other organizations; d) creating an electronic Invention Disclosure Form (e-IDF); e) scanning, attaching or downloading existing documents into the system; f) creating and editing various documents with other on-line users; g) searching inventions using on-line resources; h) receiving instantaneous search results including a rank or score based on the number and substance of the prior art results; i) submitting electronic Invention Disclosure Forms (e-IDF); j) sending and receiving electronic notifications; k) sending and receiving electronic text and voice messages; l) submitting electronic bid requests to attorneys; m) accepting electronic bids from attorney; n) compiling, ranking and selecting patent attorneys; o) drafting the patent application; responding to Patent Office Correspondence; of submitting electronic invoices; p) submitting electronic patent reports to federal agencies; q) generating patent status and expense reports; r) printing various user generated reports; s) printing standard and customized forms and; t) filing of patent applications electronically

Accessing the System. This method is designed to allow users of the system to input information directly into a computer after obtaining the access number or docket number of the technology transfer administrator.

Assigning Docket Numbers. The technology transfer administrator will query the user before assigning a user identification number or a docket number to the invention disclosure.

Entering Personal Information. Each inventor or user must have a unique user personal identification number (PIN) or social security number, driver's license number, student identification number, employee identification number, etc. The user identification number and the docket number will be used to associate the user with their technology transfer office. This is important because the system will only generate documents containing pertinent information for the user's technology transfer office.

Creating an Electronic Invention Disclosure Form

In most research collaborations, at least one of the primary inventors may be working at another university or research facility. Therefore, this system enables inventors who are not co-located to access the system, gather in an on-line meeting space to complete an electronic Invention Disclosure Form (e-IDF). Once the inventor signs onto the system, several menu choices will appear. First, the user can choose to complete a new disclosure, revise an existing (e-IDF) attach a document or submit an Invention Disclosure Form (IDF). The user can select from the menu how the e-IDF information is displayed. Some users may prefer the system to prompt them by posing several questions while others may want the system to display the form and allow them to complete the “fillable” form. If the user opts to create a new IDF the system will prompt the user to complete some or all of the following information: title of the invention, name of each inventor, home address, city, state, zip code, work telephone number, home telephone number, email address, university or company, university department, dean of the college, abstract, brief description of the invention, date of the invention, date the invention was reduced to practice, purpose of the invention, date of public disclosure, relevant patents, relevant literature, source of funding, contract or grant number, contact person at funding agency, name of potential licensee, signature of each inventor, date, signature of Dean or Chairperson, patent classification, type of invention. Additional information may be included. The e-IDF can be customized by each technology transfer office.

Where possible, each question, blank or box that requires a response should have a means for expanding or following up on a particular response. Drop down boxes or yes/no options should be used whenever possible. For example, if the user responds affirmatively to whether the invention was federally funded, then a drop down box should display all or some of the federal agencies.

Revising Editing or Modifying Documents. If the user is a returning user and would like to edit an existing e-IDF, then the “edit” feature is selected. Once the user decides to edit the e-IDF, additional menu selections are given. The system then prompts the user to select the format for completing the form. No matter which format is selected, a form can be generated at anytime simply by selecting “view e-IDF” All documents that are either created in the office or attached to a file can be revised. One of the novel features of the electronic system is the edit feature. If a user is logged on the system and is using a file, the same file can be used by others simultaneously. However, no two documents can be edited at the same time. Even though users cannot edit the same document at the same time, the system will allow the user to edit the latest draft of the document, but will not save the revision until the other user surrenders the document. When the system detects that a user is attempting to edit a file that is being used by someone else, the save feature will not appear, but the revisions will be saved in a temporary file. When that same inventor logs in again, the system will prompt the inventor to add revisions to the document or to continue without adding the revisions at this time. The prompt will occur at each log on until the inventor either makes the changes or deletes the revisions from the file. When the inventor attempts to revise the application, the system automatically displays, the last revisions appear in a highlighted color, the name of the last inventor to revise the document and the date and time of the last revision. This special editing feature works the same way when the attorney or anyone else revises or attempts to revise a document. The user will be asked whether the system should send a notification when the system is free. This is an important feature because it prevents inventors from making revisions that have already been made.

In the cases, where at least two users would like to access the system to revise the same document simultaneously, a special on-line meeting function must be selected from the main menu. Once one user is signed on, the system will ask if more than one person will be visiting today. If so, the users will be given instructions for meeting in a virtual room (e-room) where the document can be viewed by all parties. In some cases a user may want to attach a document to the e-IDF. Generally, when an inventor completes an IDF, all relevant patents or publications are attached and sent to the technology transfer office.

Attaching Documents or Files. In the electronic office, the supporting documentation can be attached to the file. The user can select the program that will be used for attaching the file. The system is capable of downloading directly from Word, WordPerfect and by scanning documents into the system. An important aspect of the attachment component is that all attached patents and literature will automatically be included in the search results and recorded on Information Disclosure Form (PTO-1449) as relevant prior art.

Searching, Scoring and Ranking. After the disclosure form has been finalized, the patent and literature search can be conducted immediately. However, while the search is usually initiated after the (IDF is created), the search can be done before, during or after the form is created. In some cases, where an inventor only wants a search, the search can be conducted instantaneously as the description and title of the invention are entered into the system. The system can be used with available free online search databases such as www.uspto.gov or www.espacenet.com. or www.delphion.com, www.wipo.int/ipdl/en/, www.surpip.gov.sg. It is also possible that search databases available through subscriptions from, but not limited to, the following companies: Micropatent, Derwent, Patentcafe, Thomson Delphion, NERAC or others not listed. The system will search the invention by using information contained on the e-IDF such as: title, abstract, brief description of the invention, type of the invention, date of the invention, date reduced to practice, purpose of the invention, relevant patent and literature references. In the event the system finds a significant number of relevant hits, the system would assign a low score/rank to the IDF and will again query the inventor and direct the inventor to re-open the disclosure to narrow or re-define the invention. If, however, the disclosure form is finalized, a rank or score, which ever is appropriate, will be automatically sent to the Technology Transfer Administrator. Each office establishes their own guidelines for the ranking or scoring of the search results. For example, some offices may want to be notified if the score is 75 or above, while others may only want notification if the score is 90 and above. The system returns a summary of the relevant references with the option of either displaying or printing the full text of the references.

The notification system automatically sends the high ranking/scoring disclosures to the administrators while the other disclosures are stored and in the virtual files for viewing at a later time. Even though the administrator automatically receive notification of the high ranking disclosures, all of the disclosures are immediately available for viewing and bidding. Each university determines how much information to include in the body of the notification. The notification of an IDF is sent via email with the appropriate documents displayed in either .doc, .wpd or .pdf or rich text formats.

The USPTO's Manual of Classification and Index can be used to narrow the patent search. The search results are based on several factors. The system is an intelligent system and can search based on an intelligent query or based on the number of occurrences. An intelligent query will attempt to understand the scope of the invention and search based on what the system thinks is the invention. The system is capable of searching several databases simultaneously and is not limited to the USPTO's search database.

Submitting the e-IDF. The system will ask if the inventors are ready to finalize and submit the form to the virtual technology transfer office. Once the disclosure is finalized and submitted, it becomes read-only to everyone except the technology transfer administrator. For editing, special permission must be granted by the system administrator. Once the inventor chooses to submit the disclosure, a completed IDF will be displayed with the option to print the form. Generally, an original signature is required, but an electronic signature may be acceptable.

Sending and Receiving Electronic Notifications and Messages. After the Disclosure form has been completed, the search performed and all the relevant documents have been attached, the user may want to leave a message for the attorney or co-inventor. At anytime, after the attorney has been selected, the attorney may begin sending or receiving electronic message from the inventors. Inherent is this feature is the ability to schedule meetings and leave messages. All messages are sent either by voicemail, email or text messaging. The format for leaving messages depends on the available information for the recipient. The system will only send messages in the format contained in the system. The default for messaging is email. For example, if the system does not detect the email address for either the sender or recipient and, if the telephone number is listed, the system will automatically send the message via voice messaging.

Once the disclosure has been submitted, the user will be presented with new menu choices including exiting the system. If a message is left for an individual or a group of individuals, an electronic notification will be sent to the appropriate people.

Drafting the Patent Application and Responding to USPTO Correspondence

After drafting a the patent application or completing a response to an Office Action can the draft document is available to the inventors. The patent attorney can electronically notify the inventors that a document is ready for review and editing. Each inventor has access to the document and can individually or simultaneously review and edit the document. The deadline for reviewing and editing the document is included in the notification to the inventors. After such time, access to the draft is denied. After the attorney reviews the changes to the documents made by the inventors, the attorney can prepare the PTO-forms using the system and make the relevant forms available to the inventors for signing and reviewing. The copies of the completed forms are included in the VTTO file. Most forms require original signatures, but in the not too distant future, electronic signatures will be used and are within the scope of this invention. At anytime while disclosing, drafting or prosecuting the patent application, either the patent attorney or inventor can send electronic notifications to schedule an on-line meeting.

The system allows only one user to edit and save at a time. If the user informs “Thomas” that the application will be drafted alone, the document will available to others for viewing and editing EXCEPT that the changes are not saved to the original document until the other user signs off or switches to another document in the file. Actions within the file individually are accessible. Logging into a file does not prevent others from using the file, but prevents two users from handling the same document at the same time UNLESS it is a session or meeting involving more than one user.

Sending and Accepting Bids

Once an invention has been completely described, disclosed and approved for patent protection, an electronic Request for Service (e-RFS) is sent from the technology transfer administrator to the attorneys. The request includes the type of application that needs to be filed (provisional or non-provisional, design or plant), the abstract, the description of the invention, the summary of the search results, the date the bidding will close and any additional information the attorneys need to submit a bid.

Participating attorneys can bid on all or some of the work. Once the bid has been received, the virtual administrator “Thomas” will confirm receipt of the bid and return a confirmation to the bidding attorney or firm. “Thomas” will also send notification to the technology transfer administrator that a bid has been received and identifies the sender. The system is capable of handling special bids such as bidding for only a portion of the work. Patent prosecution is a very long process, but most of the work that is involved can be easily divided and performed my one or several attorneys. Most patent attorneys and firms have their own style, but most patent savvy inventors prefer substance over form. Therefore, the system permits attorneys to perform all of the work or some of the work. This system makes it easy to substitute counsel. Once a new attorney is granted access to the file, the proper forms and documents are automatically updated. For example, the system will automatically generate a new Power of Attorney Form and send it electronically to the inventors for their signature—electronic or original.

The system can also accommodate special requests from the attorneys. For example, some may want to receive requests for service only for inventions involving certain subject matter for provisional patents only, for non-provisional patents only or for licensing matters only. It would not be prudent to send the attorneys that draft electrical patent applications, invention disclosures related to chemical or biotechnology inventions. The technical expertise of the attorneys will be entered into the system once the subscription agreement has been executed. At anytime during the subscription period, an attorney can update the kind of work that is desired. These are just some of the ways in which the notification and bidding process works, but can be adapted for other uses as well. After the attorney has been selected and assigned to an invention disclosure, access to the file will be granted by “Thomas,” The attorney is then free to log on to the system and correspond with the inventors and the technology transfer staff. The entire process, particularly the bidding process, can also be adapted for other forms of intellectual property protection such as trademarks and copyrights.

Compiling, Ranking and Selecting Patent Attorneys. The system is designed to select the firm or attorney that is best suited for the work. The system uses objective criteria to determine how the work will be allocated among the firms. The firms and attorneys will be selected based on several criteria including any of the following: the number of patent applications filed, other pending cases, the technical expertise of the attorney and, the amount of the bid.

Electronic Billing and Payment of Fees

Each time a patent attorney invoices the University, the docket number, description of the services rendered and the amount of the invoice will be stored. The system will prompt the attorney for the relevant patent number or application number, the type of fee and, the amount of the fee. Only the institution's Technology Transfer Administrator can approve and electronically authorize payment of the fees. Once the amount invoiced equals the amount of the contract, the virtual technology transfer administrator will send an electronic notification that the invoice cannot be accepted because the amount of the contract has been exceeded. The system will immediately return an error message to the attorney or firm that the invoice cannot be processed or authorized. Before the attorney sends the correspondence to the patent office, the system must routinely check and update, if necessary, the USPTO's current fees. In order to monitor and control costs, billing may be restricted to fixed rate contracts.

The invoicing and payment of the government fees will be done electronically as well. After the attorney has completed a project or is ready to send an invoice to the technology transfer. Payment of the invoice is authorized and paid by Electronic Funds Transfer (EFT) or manually. Most payments are made directly from the VTTO, but in a few cases it may be necessary for some offices to make direct payments from the Accounts Payable department of a technology transfer office. The system keeps track of the fees and expenses for the deposit account for each office at the USPTO.

Paying Patent Fees to the USPSTO

As each office joins the VTTO, the system automatically generates the form used for establishing a deposit account with the USPTO. The system manages the Account, but only the technology transfer administrator for each office is authorized to make fee payments. In cases where the client does not have a physical technology transfer office, an authorized fiscal representative must authorize fee payments on behalf of the institution.

Generally, electronic systems are desirable because of the database and reporting capabilities. Once information is entered into the system, it remains there until it is deleted. Universities are expected to comply with certain Federal Rules regarding inventions, so such a system addresses compliance issues as well. Currently, all Federal agencies require universities to report the disclosure of their inventions within sixty days after the disclosure is to the university by the inventor. This requirement can be easily overlooked. However, the reporting of this required function can be handled instantaneously. Once the inventor enters the contract or grant number and the name of the Federal agency into the computer, an electronic report is immediately sent to the agency.

Federal Patent Reporting

Another critical feature of the system is federal patent reporting component. If the inventor indicates on the IDF that the invention was Federally funded, menus will appear prompting the inventor to identify the federal agency, the contract or grant number, the principal investigator and title of the invention. When the inventor submits the Disclosure Form to the VTTO, pertinent information will be simultaneously disclosed to the Federal granting agency. Ideally, all patent reports to the Federal agencies will be submitted electronically, however some agencies do not have a way to accept electronic forms. Currently, only NIH and NASA have electronic systems for online filing patent or invention reports. NIH's system is called iedison and can be accessed online at www.iedison.gov. Additionally, patent reports can be filed using NIH's iedison for the following agencies: the US Department of the Army, the Center for Disease Control, the Department of Energy, the Environmental Protection Agency, the Food and Drug Administration, the US Department of Navy/Office of Naval Research, National Institutes of Health, the National Institute of Standards and Technology, the Nation Ocean and Atmospheric Agency, the National Science Foundation, the United States Air Force and, the United States Department of Agriculture. See www.iedison.gov for a complete listing of the Federal agencies using iedison. NASA's system is called eNTRe and is accessible online at www.invention.nasa.gov. For Federal agencies that do not accept electronic reports, the system will automatically generate the appropriate form to be mailed. The system stores the name, telephone number, email address and mailing address for federal agency contacts.

The system sends periodic reminders to the Technology Transfer Administrator, beginning from the date of disclosure, up to 24 months later, regarding the election requirement. All non-profits opting to own the federal inventions, must formally elect to take title to the invention. The election must be made within two years from the disclosure date. It will set a future electronic reminder up to 18 months on a reminder to the Technology Transfer Administrator to elect to take title to the invention according to the federal rules.

Generating Electronic Forms

One important feature of the database is that it will automatically generate and send appropriate form letters to the inventors regarding the time, receipt and status of the Invention Disclosure. At the time the Invention Disclosure Form is entered, a docket number and the password will be assigned for access to the file. The following are typical forms that can be accessed using the system: Invention Disclosure Form (IDF), Assignment Form (AF), Information Disclosure Form (IDF) (PTO-1449), Transmittal Form (TF), Utility Patent Application Cover Sheet (UPACS), Provisional Patent Application (PPA) Cover Sheet, Oath/Declaration Form (O/DF), Confidential Disclosure Agreement (CDA), Power of Attorney Form (PAF). This includes forms that are listed and accessible on the U.S. Patent and Trademark Office's web site. A link to the following PTO's forms database is provided. (http://www.uspto.gov/web/forms/index.html#startforms)

VTTO can be used to generate several kinds of forms, but there is one with unique features. The VTTO has the ability to generate documents for the appropriate inventor within a specific institution. Documents and forms are customized for each participating technology transfer office. This is done even where co-inventors are from different universities or technology transfer offices. Also at any time, the system can generate a file with a copy of every document sent and received from the VTTO file.

Patent Reporting and Expense Notification.

One of the most helpful features of the VTTO is that a client can generate, view or print a status report. The system is capable of displaying the information in various formats. The information can be easily imported or merged into a presentation or document. The system creates, downloads or saves reports to various formats including: .doc, .wpd, rich text format, .pdf, etc. The status report can be customized to include the number of disclosures submitted, the number of provisional patents filed, the number of non-provisional patents filed, the number of patents filed for each College or Department, the number of federally funded inventions and, the number of inventions filed by students.

The expense notification feature is an essential tool for technology transfer offices. Each time a government fee or attorney invoice is received or paid, the Technology Transfer Administrator will be notified. Notification will include at least the following information, but may include more than what is indicated here: The amount of the payment, the total expenses incurred for the year, total expenses paid for the year and the current balance.

What is claimed:

1. A network comprising computers, servers and software permitting users to accessing a secure on-line system for entering, retrieving, displaying, editing, storing and printing technology transfer and intellectual property information.

2. The network of claim 1 further comprising the following steps:
a. Accessing a network
b. Assigning docket numbers
c. Entering personal information of or concerning inventors, inventor's university, other organizations
d. Creating an electronic Invention Disclosure Form (e-IDF)
e. Scanning, attaching or downloading existing documents into the system
f. Creating and editing various documents with other on-line users;
g. Searching invention using on-line resources
h. Receiving instantaneous search results including a rank or score based on the number and substance of the prior art results
i. Submitting electronic Invention Disclosure Forms (e-IDF)
j. Sending and receiving electronic notifications
k. Sending and receiving electronic text and voice messages
l. Submitting electronic bid requests to attorneys
m. Accepting electronic bids from attorney
n. Compiling, ranking and selecting patent attorneys
o. Drafting the Patent Application;
p. Responding to Patent Office Correspondence;
q. Submitting electronic invoices
r. Generating various reports
s. Submitting electronic patent reports to Federal agencies
t. Generating Patent Status and Expense Reports
u. Printing Reports
v. Printing Forms
w. Filing of patent applications electronically

3. A method of managing and coordinating technology transfer and intellectual property related activities comprising computers, servers and software for users involving accessing a secure on-line system for entering, retrieving, displaying, editing, storing and printing technology transfer and intellectual property information.

4. The method of claim 3 further comprising the following steps:
a. Accessing a network
b. Assigning docket numbers
c. Entering personal information of or concerning inventors, inventor's university, other organizations
d. Creating an electronic Invention Disclosure Form (e-IDF)
e. Scanning, attaching or downloading existing documents into the system
f. Creating and editing various documents with other on-line users;
g. Searching invention using on-line resources
h. Receiving instantaneous search results including a rank or score based on the number and substance of the prior art results
i. Submitting electronic Invention Disclosure Forms (e-IDF)
j. Sending and receiving electronic notifications
k. Sending and receiving electronic text and voice messages
l. Submitting electronic bid requests to attorneys
m. Accepting electronic bids from attorney
n. Compiling, ranking and selecting patent attorneys
o. Drafting the Patent Application;
p. Responding to Patent Office Correspondence;
q. Submitting electronic invoices
r. Generating various reports
s. Submitting electronic patent reports to Federal agencies
t. Generating Patent Status and Expense Reports
u. Printing Reports
v. Printing Forms
w. Filing of patent applications electronically

5. The method of claim 3 wherein people, computers, servers, documents, forms, and courses interact and correspond in a virtual environment or Virtual Technology Transfer Office (VTTO).

6. The method of claim 3 wherein the method involves at least four types of users consisting of technology transfer administrator, attorney, participating technology transfer administrators and individual users.

7. The method of claim 6 wherein the individual users are selected from inventors, licensee, licensor, professor, student, university administrator, independent inventor, corporate employee, government employee.

8. The method of claim 3 wherein users access the system using unique personal identification number such as social security number, driver's license number, student identification number, docket number or any other unique identifier.

9. The method of claim 3 wherein users can enter data and interact with the network using any of following means internet, web, intranet, personal data assistants (PDAs), handheld devices, cell phones, personal computers.

10. The method of claim 3 wherein users create, edit and attach documents individually, simultaneously or in tandem with other users.

11. The method of claim 10 wherein the documents that are created, scanned, downloaded and edited in the VTTO are the Invention Disclosure Form, Provisional Patent Application, Non-provisional Patent Application, PCT Application and Responses to Patent Office Correspondence and other necessary technology transfer related documents.

12. The method of claim 11 wherein the documents are created and edited in the VTTO individually, simultaneously or in tandem with other users.

13. The method of claim 3 wherein users can conduct patent and literature searches and receive immediate or instantaneous feedback before, after or while the invention disclosure form is created.

14. The method of claim 6 wherein the user completes an electronic invention disclosure form, conducts a search, receives immediate feedback and views the prior art.

15. The method of claim 15 wherein the user is capable of narrowing the patent search.

16. The Method of claim 15 wherein the invention disclosure is scored or ranked based on the number and substance of references retrieved.

17. The Method of claim 14 wherein a notification can be sent automatically to the virtual Technology Transfer Administrator when the feedback or prior art satisfies the predetermined criteria.

18. The Method of claim 3 wherein the electronic notifications and messages are sent to and from any of the users by voice mail, email or text messaging.

19. The Method of claim 3 wherein the VTTO administrator submits and accepts Requests for Service or bids in the virtual environment

20. The Method of claim 3 wherein the VTTO automatically compiles and ranks patent attorneys that bid on work.

21. The Method of claim 3 wherein the technology transfer administrator selects the patent attorney electronically selected or selects another patent attorney.

22. The Method of claim 3 wherein users can submit invoices, authorize payments and make payments electronically using the system in VTTO.

23. The Method of claim 3 wherein various reports and forms can be created, reviewed, and edited in the VTTO.

24. The Method of claim 3 wherein patent applications and other USPTO correspondence are filed electronically.

25. The Method of claim 3 wherein the VTTO administrator interacts with users in a “human like” or “real life” manner.

26. The Method of claim 3 wherein the VTTO administrator responds to voice activated and manually entered responses.

27. The method of claim 3 wherein the patent application is selected from the group consisting of provisional, non-provisional and PCT applications.
